(19) United States
(12) Patent Application Publication
(10) Pub. No.: US 2010/0236492 A1
(43) Pub. Date: Sep. 23, 2010

(54) METALLIZED ANIMAL HOUSE CURTAIN

(75) Inventor: RAFAEL JANUARIO CALABRESE, Sao Paulo (BR)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E.I. DU PONT DE NEMOURS AND COMPANY, Wilmington, DE (US)

(21) Appl. No.: 12/726,493

(22) Filed: Mar. 18, 2010

Related U.S. Application Data
(60) Provisional application No. 61/161,194, filed on Mar. 18, 2009.

(51) Int. Cl. B32B 15/14; A01K 31/18; A47H 23/08

(52) U.S. Cl. 119/437; 442/378; 442/232

(57) ABSTRACT

An animal house curtain comprising a metallized composite sheet can be made from a sheet layer having two outer surfaces, the sheet layer comprising at least one of a nonwoven fabric, woven fabric, nonwoven fabric-film laminate, woven fabric-film laminate, film and composites thereof, and at least one coating on at least one outer surface of the sheet layer, said coating comprising a metal coating layer having a thickness between about 15 nanometers and about 200 nanometers adjacent the outer surface of the sheet layer and wherein the emissivity of the composite sheet is less than about 0.50. Optionally, an organic coating layer of a composition containing a material selected from the group consisting of compounds, polymers, oligomers and combinations thereof, having a thickness between about 0.2 micrometer and about 2.5 micrometers can be deposited on the metal layer.

### BACKGROUND OF THE INVENTION

1. Field of the Invention

The present invention relates to animal production and in particular a product for enhancing animal production.

2. Description of the Related Art

In various industries such as those involving agriculture, it is often necessary to maintain the air temperature in the interior of a building within a desired temperature range. One such application where control of the temperature within a building is extremely important is in connection with poultry houses. Such facilities are typically used to house chickens which are being grown for eventual slaughter or which are being used for egg production. Such facilities are designed for reducing undesired high temperatures by using window curtains, fans and water misters. Excessive heat entering a poultry house may affect a chicken physiologically. Excessive heat can stress the chickens ultimately resulting in lower chicken productivity.

In a large scale poultry house, typically twenty thousand to twenty-eight thousand chickens may be housed at a given time. If the ambient temperature in a poultry house is too high, the respiration of the chickens and the waste by-products within the poultry house can quickly give rise to a build up of ammonia and heat within the house which may be physiologically detrimental to the chickens. In extreme cases, such as on hot summer days, significant animal mortality may result. Even if mortality does not result, high temperatures can produce significant physiological stress on the chickens that results in inhibited growth, reduced egg production, and/or disease.

In many poultry houses the window openings are covered with curtains of sheets that are colored gray on one side of the sheet and black on the other side of the sheet. The gray side faces the outside of the poultry house and the black side faces the inside of the poultry house. The gray and black color of the sheets reduces the amount of light that enters the poultry house which can have a detrimental impact on the chickens. Unfortunately, these sheets absorb heat from outside and transmit or emit heat into the poultry house causing the air temperature in the poultry house to rise to undesirable levels.

In addition, these curtains of gray/black sheets block out most sunlight which can require the use of artificial lighting inside of the poultry house. Also, when artificial lighting is used, the black color of these curtains does not reflect light very well which can require additional artificial lighting.

It is therefore desirable in the industry to provide an improved curtain for reducing undesirable high temperatures in poultry houses while continuing to optimize light transmission and reflection.

### BRIEF SUMMARY OF THE INVENTION

The present invention is directed to an animal house curtain comprising a metallized composite sheet made from a sheet layer having two outer surfaces, the sheet layer comprising at least one of a nonwoven fabric, woven fabric, nonwoven fabric-film laminate, woven fabric-film laminate, film and composites thereof, and at least one coating on at least one outer surface of the sheet layer, said coating comprising a metal coating layer having a thickness between about 15 nanometers and about 200 nanometers adjacent the outer surface of the sheet layer and wherein the emissivity of the composite sheet is less than about 0.50. Optionally, an organic coating layer of a composition containing a material selected from the group consisting of compounds, polymers, oligomers and combinations thereof, having a thickness between about 0.2 micrometer and about 2.5 micrometers can be deposited on the metal layer.

The present invention is also directed to an animal house comprising at least one animal house curtain of the aforesaid character, and a method of raising animals comprising providing a facility for housing animals having one or more openings in the sidewalls thereof and providing at least one animal house curtain of the aforesaid character disposed over said opening(s) to provide a thermal barrier to protect the animals from undesirable heat. The curtain is preferably arranged so that the metallized layer faces the outside sunlight.

### DETAILED DESCRIPTION OF THE INVENTION

The terms “nonwoven fabric”, “nonwoven sheet”, “nonwoven layer”, and “nonwoven web” as used herein refer to a structure of individual strands (e.g. fibers, filaments, or threads) that are positioned in a random manner to form a planar material without an identifiable pattern, as opposed to a knitted or woven fabric. The term “fiber” is used herein to include staple fibers as well as continuous filaments. Examples of nonwoven fabrics include meltblown webs, spunbond nonwoven webs, flash spun webs, staple-based webs including carded and air-laid webs, spunlaced webs, and composite sheets comprising more than one nonwoven web.

The term “woven sheet” is used herein to refer to sheet structures formed by weaving a pattern of intersecting warp and weft strands.

The term “spunbond fibers” as used herein means fibers that are melt-spun by extruding molten thermoplastic polymer material as fibers from a plurality of fine, usually circular, capillaries of a spinneret with the diameter of the extruded fibers then being rapidly reduced by drawing and then quenching the fibers.

The term “meltblown fibers” as used herein, means fibers that are melt-spun by meltblowing, which comprises extruding a melt-processable polymer through a plurality of capillaries as molten streams into a high velocity gas (e.g. air) stream.

The term “spunbond-meltblown-spunbond nonwoven fabric” (“SMS”) as used herein refers to a multi-layer composite sheet comprising a web of meltblown fibers sandwiched between and bonded to two spunbond layers. Additional spunbond and/or meltblown layers can be incorporated in the composite sheet, for example spunbond-meltblown-meltblown-spunbond webs (“SMMS”), etc.

The term “plexifilamentary” as used herein, means a three-dimensional integral network or web of a multitude of thin, ribbon-like, film-fibril elements of random length and with a mean film thickness of less than about 4 micrometers and a median fibril width of less than about 25 micrometers. In plexifilamentary structures, the film-fibril elements are generally coextensively aligned with the longitudinal axis of the structure and they intermittently unite and separate at irregular intervals in various places throughout the length, width and thickness of the structure to form a continuous three-dimensional network. A nonwoven web of plexifilamentary film-fibril elements is referred to herein as a “flash spun plexifilamentary sheet”.

As used herein, the term “tape” refers to a flattened strand, such as flattened strands formed from a slit film.

As used herein, the term “metal” includes metal alloys as well as metals.

The animal house curtain may in fact be used as a curtain in housing for a wide variety of animals such as chickens, turkeys, hogs or virtually any other animal requiring a relatively controlled temperature and light environment for adequate growth or production of food. While the following description of the various preferred curtains of the present disclosure will be directed principally with reference to poultry, this is in no way intended to limit the application of the disclosure to poultry. Those skilled in the art will appreciate that the curtains described herein are readily adaptable with little or no modification for use with a wide variety of animals which may be sensitive to significant variations in ambient temperature.

It is known in the art to use moisture vapor permeable (breathable) metallized sheets as house wrap in building construction. The metallized sheets allow moisture vapor to pass through the sheet, thus preventing moisture condensation in insulation that is installed behind the sheet, while at the same time providing a barrier to air and liquid water and enhancing the energy efficiency of the building. U.S. Patent Application Publication No. 2006/0040091, the contents of which are hereby incorporated by reference, describes a metallized sheet suitable for house wrap.

Whereas it is known to use metallized sheets in the walls in a building construction, metallized sheets would not be used in the window openings. However, in many poultry houses the window openings in the sidewalls are often covered with curtains of gray/black colored sheets. The sheets are gray/black in color to help reduce the amount of light that enters the poultry house which can have a detrimental impact on the chickens. Unfortunately, these gray/black sheets transmit heat into the poultry house causing the air temperature in the poultry house to rise to undesirable levels.

Surprisingly, it has been discovered that metallized sheets can be used as curtains to cover window openings in poultry houses. These metallized sheets can reduce the amount of heat that is transmitted into the poultry house.

The present invention relates to metallized composite sheets formed by coating at least one side of a sheet layer with at least one metal layer and, optionally, at least one thin organic layer on the side of the metal layer opposite the sheet layer. The coatings are preferably formed under vacuum using vapor deposition techniques under conditions that substantially coat the sheet layer. The composite sheets have good thermal barrier properties, especially when compared to the incumbent black sheets currently used. The composite sheets can also be selected to provide a high barrier to intrusion by liquid water and air, to allow moisture vapor transmission, to regulate or control the amount of light transmission and to provide adequate strength which are also important qualities in poultry house curtains.

Metallized composite sheets according to the invention can be made as generally described in U.S. Patent Application Publication No. 2006/0040091, the contents of which are hereby incorporated by reference.

Suitable sheet layers include woven fabrics, such as sheets of woven fibers or tapes, or nonwoven fabrics, such as flash-spun plexifilamentary sheets, spunbond nonwoven sheets, spunbond-meltblown nonwoven sheets, spunbond-meltblown-spunbond nonwoven sheets, and laminates that include a nonwoven or woven fabric or scrim layer and a film layer, such as a microporous film, a perforated film or a nonperforated film. The sheet layer can comprise a moisture vapor permeable sheet that has been coated using conventional coating methods. For example, sheets of woven tapes can be used that have been coated with a polymeric film layer and microperforated. The sheet layer may be formed from a variety of polymeric compositions. For example, polyolefins such as polypropylene or high density polyethylene, polyesters, or polyamides can be used.

In one embodiment, the sheet layer is a flash spun plexifilamentary polyolefin sheet such as Tyvek® flash spun high density polyethylene, available from E. I. du Pont de Nemours and Company, Inc., Wilmington, Del. (hereafter DuPont). Suitable flash spun plexifilamentary film-fibril materials may also be made from polypropylene. The moisture vapor permeable sheet can be a laminate of a flash spun plexifilamentary sheet with one or more additional layers, such as a laminate comprising a flash spun plexifilamentary sheet and a melt-spun spunbond sheet. Flash spinning processes for forming web layers of plexifilamentary film-fibril strand material are disclosed in U.S. Pat. No. 3,081,519 (Blades et al.), U.S. Pat. No. 3,169,899 (Steuber), U.S. Pat. No. 3,227,784 (Blades et al.) and U.S. Pat. No. 3,851,023 (Brethauer et al.), the contents of which are hereby incorporated by reference.

In some cases it may be desirable to use a sheet layer that is substantially air impermeable. For example, the sheet layer can comprise a laminate of a nonwoven or woven fabric or scrim and a film layer, wherein the film layer is a microporous film or a monolithic film. Generally, one or more film layers are sandwiched between outer nonwoven or woven fabric or scrim layers and the metal and organic coating layers are deposited on at least one of the outer layers such that an outer organic coating layer forms an outside surface of the composite sheet. In one such embodiment, a film layer is sandwiched between two staple fiber nonwoven layers, or two continuous filament nonwoven layers, or two woven fabrics. The outer fabric or scrim layers can be the same or different.

Wherein the sheet layer is porous, the metal layers and optional organic layers are deposited on the porous surface such that only the exposed or “outer” surface of the fibers or film on the coated side is coated, without covering the pores. This includes the internal surfaces of the walls of the interstitial spaces or pores between the fibers, as well as the fiber surfaces that are exposed when viewed from the outer surface of the sheet layer on the coated side(s); but the surfaces of fibers in the interior structure of the fabric remain uncoated.

Metals suitable for forming the metal layer(s) of the composite sheets of the present invention include aluminum, gold, silver, zinc, tin, lead, copper, and their alloys. The metal alloys can include other metals, so long as the alloy composition provides a low emissivity composite sheet. Each metal layer has a thickness between about 15 nm and about 200 nm, or between about 30 nm and about 60 nm. In one embodiment, the metal layer comprises aluminum having a thickness between about 15 and about 150 nm, or between about 30 and about 60 nm. Methods for forming the metal layer are known in the art and include resistive evaporation, electron beam metal vapor deposition, or sputtering. If the metal layer is too thin, the desired thermal barrier properties will not be achieved. If the metal layer is too thick, it can crack and flake off. Generally it is preferred to use the lowest metal thickness that will provide the desired thermal barrier properties. The metal layer reflects infrared radiation or emits little infrared radiation, providing a thermal barrier that reduces energy loss and keeps the poultry house cooler in the summer and warmer in the winter. Also, the metal thickness can impact the visible light transmission with lower metal thickness providing higher visible light transmission.

Suitable compositions for the optional organic coating layer(s) include polyacrylate polymers and oligomers. The coating material can be a cross-linked compound or composition. Precursor compounds suitable for preparing the organic coating layers include vacuum compatible monomers, oligomers or low molecular weight (MW) polymers and combinations thereof. Vacuum compatible monomers, oligomers or low MW polymers should have high enough vapor pressure to evaporate rapidly in the evaporator without undergoing thermal degradation or polymerization, and at the same time should not have a vapor pressure so high as to overwhelm the vacuum system. The ease of evaporation depends on the molecular weight and the intermolecular forces between the monomers, oligomers or polymers. Typically, vacuum compatible monomers, oligomers and low MW polymers useful in this invention can have weight average molecular weights up to approximately 1200. Vacuum compatible monomers used in this invention are preferably radiation polymerizable, either alone or with the aid of a photoinitiator, and include acrylate monomers functionalized with hydroxyl, ether, carboxylic acid, sulfonic acid, ester, amine and other functionalities.

The coating material may be a hydrophobic compound or composition. The coating material may be a crosslinkable, hydrophobic and oleophobic fluorinated acrylate polymer or oligomer, according to one preferred embodiment of the invention. Vacuum compatible oligomers or low molecular weight polymers include diacrylates, triacrylates and higher molecular weight acrylates functionalized as described above, aliphatic, alicyclic or aromatic oligomers or polymers and fluorinated acrylate oligomers or polymers. Fluorinated acrylates, which exhibit very low intermolecular interactions, useful in this invention can have weight average molecular weights up to approximately 6000. Preferred acrylates have at least one double bond, and preferably at least two double bonds within the molecule, to provide high-speed polymerization. Examples of acrylates that are useful in the coating of the present invention and average molecular weights of the acrylates are described in U.S. Pat. No. 6,083,628 and WO 98/18852.

Vacuum vapor deposition methods known in the art are preferred for depositing the metal and organic coatings. The thickness of the metal and organic coatings are preferably controlled within ranges that provide a composite sheet having an emissivity less than about 0.50, even less than about 0.20, and even less than about 0.10.

The outer organic coating layer preferably has a thickness between about 0.2 micrometer and about 2.5 micrometers, which corresponds to between about 0.15 g/m² to about 1.9 g/m² of the organic coating material.

The thermal barrier properties of a material can be characterized by its emissivity. Emissivity is the ratio of the power per unit area radiated by a surface to that radiated by a black body at the same temperature. A black body therefore has an emissivity of one and a perfect reflector has an emissivity of zero. The lower the emissivity, the higher the thermal barrier properties. Polished aluminum has an emissivity between 0.039 and 0.057, silver between 0.020 and 0.032, and gold between 0.018 and 0.035.

A layer of uncoated aluminum generally forms a thin aluminum oxide layer on its surface upon exposure to air and moisture. The thickness of the oxide film increases for a period of several hours with continued exposure to air, after which the oxide layer reaches a thickness that prevents or significantly hinders contact of oxygen with the metal layer, reducing further oxidation. Oxidized aluminum has an emissivity between about 0.20 to about 0.31. By minimizing the degree of oxidation of the aluminum by depositing the outer organic coating layer prior to exposing the aluminum layer to the atmosphere, the emissivity of the composite sheet is significantly improved compared to an unprotected layer of aluminum. The outer organic coating layer also protects the metal from mechanical abrasion during roll handling, transportation and end-use installation.

The animal house curtain has preferred properties of a visible light transmission between about 0.1% and about 10% wherein the light source is located on the side of the sheet layer containing the metal coating layer, a visible light reflection greater than about 60% wherein the light source is located on the side of the sheet layer not containing a metal coating layer, and a moisture vapor transmission rate of more than about 35 g/m²/24 hr.

### Test Methods

In the non-limiting examples that follow, the following test methods were employed to determine various reported characteristics and properties. ASTM refers to the American Society of Testing Materials. ISO refers to the International Standards Organization. TAPPI refers to Technical Association of Pulp and Paper Industry.

For Examples using sheet layers in roll form, three samples (S1, S2, and S3) were taken from the beginning, middle, and end of each roll and multiple measurements made on each of these samples and averaged for hydrostatic head, Gurley Hill Porosity, MVTR, and emissivity measurements.

Basis Weight was determined by ASTM D-3776, which is hereby incorporated by reference and reported in g/m².

Thickness of the metal layer was measured on cryomicrotomed specimens using transmission electron microscopy and is reported in nanometers.

Thickness of the organic layer was measured on cryomicrotomed specimens using transmission electron microscopy and is reported in micrometers.

Emissivity is a measure of the heat absorbance and reflectance properties of a material and was measured according to ASTM C1371-98 and ASTM C408-71 using a Model AE D&S Emissometer (manufactured by Devices and Services Company, Dallas, Tex.) with the metallized side of the sheet samples facing the radiation source. The detector was heated to 82° C. and calibrated with standards having a low emissivity (reflective, emissivity=0.07) and high emissivity (absorbing, emissivity=0.89). The instrument was calibrated at the beginning and end of each measurement and at least once every 30 minutes. The emissivity was measured for a total of 27 samples for each Example and the measurements were averaged to obtain the average emissivity reported in the Examples. Three emissivity measurements were obtained from each of three areas, close to both edges and the center of the roll width for each S1, S2, and S3 sample. The same measurements were repeated three times, each time with a new S1, S2, and S3 for a total of 27 emissivity measurements that were averaged to obtain the average emissivity reported in the Examples.

Visible Light Transmission is a measure of the amount of visible light that passes through a material and Visible Light Reflectance is a measure of the amount of visible light that reflects off of a material and both were measured according to ASTM E1164-02 (Standard Practice for Obtaining Spectrophotometric Data for Object-Color Evaluation), which is hereby incorporated by reference, and is reported in %.

Moisture Vapor Transmission Rate is a measure of the moisture vapor permeability of a material and was measured according to ASTM D6701-01, which is hereby incorporated by reference, and is reported in units of g/m²/24 hr.

### EXAMPLES

These examples concern curtains used in poultry houses.

### Example

The Example was a flash spun plexifilamentary sheet of 82 g/m² basis weight Tyvek® 1580B HomeWrap®, available from DuPont with a coating of aluminum applied to one side of the Tyvek® and an organic lacquer coating applied to the aluminum coating.

The above metallized sheet was sized to fit over each curtain opening in the sidewalls of the poultry house and then attached to the poultry house over each opening with the metallized side of the sheet facing outside the poultry house.

The metallized sheet curtain had an emissivity of 0.16. The visible light transmission was 0.4% wherein the light source is located on the side of the sheet layer containing the metal coating layer. The visible light reflection was 93.8% wherein the light source is located on the side of the sheet layer not containing a metal coating layer. The moisture vapor transmission rate was 1941 g/m²/24 hr measured from the metalized side of the sheet and was 1503 g/m²/24 hr measured from the non-metallized side of the sheet. The metallized sheet curtain was found to reduce the ambient temperature of the poultry house by 3.9° C.

The light transmission was adequate to provide a soft glow of daylight into the poultry house. The light reflection on the curtains inside the poultry house was very good. The moisture vapor transmission rate was high and helped to circulate the air.

### Comparative Example

This Comparative Example is a 183 g/m² basis weight nonwoven polypropylene sheet that is colored black on one side and gray on the other side that is currently in use as a poultry house curtain. The above sheet was sized to fit over each curtain opening in the sidewalls of the poultry house and then attached to the poultry house over each opening with the gray side of the sheet facing outside of the poultry house and the black side of the sheet facing inside of the poultry house.

The sheet curtain had a visible light transmission of essentially 0% wherein the light source is located on the side of the sheet layer containing the gray colored layer. The visible light reflection was not measured. The moisture vapor transmission rate was 7 g/m²/24 hr measured from the gray colored side of the sheet and was 19 g/m²/24 hr measured from the black side of the sheet. The sheet curtain was found to reduce the ambient temperature of the poultry house by 0.9° C.

The light reflection on the curtains inside the poultry house was very poor. The moisture vapor transmission rate and the Gurley Hill porosity were low indicating poor air circulation.

Comparing the Example of the invention with the Comparative Example shows that the Example has better visible light transmission, in fact, the Comparative Example passed very little daylight into the poultry house. Also, the Example has a higher moisture vapor transmission rate than the Comparative Example. Also, the ambient temperature of the poultry house using the Example curtains showed a net lower temperature reduction of 3° C. opposite the Comparative Example curtains.

What is claimed is:

1. An animal house curtain comprising:
a metallized composite sheet comprising:
a sheet layer having two outer surfaces, the sheet layer comprising at least one of a nonwoven fabric, woven fabric, nonwoven fabric-film laminate, woven fabric-film laminate, film and composites thereof, and at least one coating on at least one outer surface of the sheet layer, said coating comprising:
a metal coating layer having a thickness between about 15 nanometers and about 200 nanometers adjacent the outer surface of the sheet layer; and
wherein the emissivity of the composite sheet is less than about 0.50.

2. The animal house curtain of claim 1, wherein the nonwoven fabric is selected from the group consisting of spunbond fabrics, spunbond-meltblown fabrics, spunbond-meltblown-spunbond fabrics, flash spun plexifilamentary sheets, and composites thereof.

3. The animal house curtain of claim 1, wherein the nonwoven fabric-film laminate, woven fabric-film laminate and film comprise films selected from the group consisting of microporous films, perforated films and nonperforated films.

4. The animal house curtain of claim 1, wherein the metal is selected from the group consisting of aluminum, silver, copper, gold, tin, zinc, and their alloys.

5. The animal house curtain of claim 4, wherein the metal is aluminum.

6. The animal house curtain of claim 1, wherein the coating substantially covers at least one of the outer surfaces of the porous sheet while leaving the pores substantially uncovered.

7. The animal house curtain of claim 1, which has a visible light transmission between about 0.1% to about 10% wherein the light source is located on the side of the sheet layer containing the metal coating layer.

8. The animal house curtain of claim 1, which has a visible light reflection greater than about 60% wherein the light source is located on the side of the sheet layer not containing a metal coating layer.

9. The animal house curtain of claim 1, which has a moisture vapor transmission rate of more than about 35 g/m²/24 hr.

10. The animal house curtain of claim 1, further comprising an organic coating layer of a composition containing a material selected from the group consisting of compounds, polymers, oligomers and combinations thereof, having a thickness between about 0.2 micrometer and about 2.5 micrometers deposited on the metal layer.

11. The animal house curtain of claim 10, wherein the organic coating layer comprises a cross-linked polyacrylate.

12. The animal house curtain of claim 10, wherein the organic coating layer comprises a fluorinated acrylate oligomer.

13. The animal house curtain of claim 1, wherein the animal house is a poultry house.

14. An animal house comprising at least one animal house curtain according to claim 1.
